(19) United States
(12) Patent Application Publication
(10) Pub. No.: US 2009/0167977 A1
(43) Pub. Date: Jul. 2, 2009

(54) IN-CAR INTEGRATED LCD MONITOR WITH MULTIMEDIA PLAYER

(76) Inventors: Mark Lee, Chung Ho City (TW); Jung-Chang Wu, Chung Ho City (TW); Wei-Yu Wu, Chung Ho City (TW)

Correspondence Address: SINORICA, LLC, 2275 Research Blvd., Suite 500, ROCKVILLE, MD, 20850, US

(21) Appl. No.: 11/968,426

(22) Filed: Jan. 2, 2008

(51) Int. Cl. G02F 1/1333

(52) U.S. Cl. 349/58

(57) ABSTRACT

An interior liquid crystal and multimedia data display is provided. The interior liquid crystal and multimedia data display comprises a container being installed in the back of the headrest for containing other equipments. A monitor is set in the container and the container is axially connected with the monitor at a bottom edge thereof, therefore the monitor can be turned over from or pushing back to the container. A control panel is set below the monitor with a plurality of function keys and a direction key. An extension slot is set above the monitor and concealed between the monitor and the container. A peripheral panel is set in the headrest at a side thereof, in which the peripheral panel has a surface with a plurality of output ports and a plurality of input ports for being connected to other audio/video equipments.

### BACKGROUND OF THE INVENTION

1. Field of the Invention

The present invention provides an interior liquid crystal and multimedia data display. More particularly, the present invention is related to a well-functioned car-used multimedia data player which is easy to operate in a car.

2. Descriptions of the Related Art

As the quality of life improves gradually, modern people are making the most of daily amusement. In addition, with technology progress and the adjustment of the steps of life, video/audio entertainment becomes part of life of most people.

Because of the fatigue of work or school, people think highly of outdoor activities, which not only relieves fatigue, but also contributes to peace of mind, evaluating spiritual health. And accompanied with outdoor activities are traffic problems.

The nightmare scenario for modern people when traveling is traffic problems. Backseat passengers can do nothing when the drivers are concentrating on driving. When it comes to long-distance driving or traffic jams, the livelong waiting is simply a torture for the passengers, which reduce a lot of the fun of traveling. Therefore, it is necessary to offer some entertainment of the car. Although some people try to read to cheat time, the dark, bumpy space is not a good reading condition. Therefore, as the multimedia technology improves, people tend to install multimedia equipments in the car, which not only offer entertainment, but also provide necessary information for work that makes the business go smoothly.

The multimedia apparatuses presently provided in a car, including monitors, speakers, control keys and disc drives for video/audio CDs, are mostly designed on the headrest of the seat, getting more complicated to operate as the function is improved. However, the main idea of car-used-multimedia apparatus is to offer entertainment, with which complicated operation doesn't fit the limited in-car space. Therefore, an apparatus that is too complicated is not appropriate for car use.

For the above reasons, the inventor of the present invention has set about improving car-used multimedia data players from a humanistic point of view, simplifying the functions and structures yet having the original capability of the players remained. After long-term researching and developing, the present interior liquid crystal and multimedia data display is finally made successfully.

### SUMMARY OF THE INVENTION

The primary object of the present invention is to provide an interior liquid crystal and multimedia data display, which is easy and convenient to operate, providing the most comfortable multimedia trip for the passengers.

Another object of the present invention is to provide an interior liquid crystal and multimedia data display, in which many kinds of memory card apparatuses compliant with different standards can be installed; multimedia signals can be inputted through other digital equipments as well. There is a diversity of the playing content.

Another object of the present invention is to provide an interior liquid crystal and multimedia data display with a firm structure not easily influenced along with the vibration caused from the car driving, which is module-designed and is easy to maintain and repair.

The interior liquid crystal and multimedia data display that reaches the aforementioned objects has a main apparatus set in the back of a headrest installed on the seat of a car, including a container, a monitor, a control panel, an extension slot, and a peripheral panel. The container is installed in the back of the headrest to contain other apparatuses and related circuits. The monitor is set in the container, wherein the container is axially connected to the monitor at a bottom edge thereof, thereby the monitor is able to be turned over outwardly from the container or to be pushed back toward the container to be leveled with the headrest in order not to occupy the narrow space in the car, and can be screwed outward to lay out when necessary to joint an extension slot set at the upper edge. The extension slot is mainly a memory slot in which memory cards in SD, MMC, MS, SM, XD standards and etc. are readable, and the video/audio information stored in the memory cards can be loaded. The control panel, for the use of controlling different functions of the present invention, is set below the monitor with a plurality of function keys and a direction key. And the peripheral panel is set at a side of the headrest, in which the peripheral panel has a surface with a plurality of output ports, including but not limited to ports for microphones, speakers, USB and IEEE 1394, and a plurality of input ports for being connected to other multimedia equipments or receiving video/audio signals from other digital equipments and directly playing on the monitor.

### BRIEF DESCRIPTION OF THE DRAWINGS

The drawings disclose an illustrative embodiment of the present invention which serves to exemplify the various advantages and objects hereof, and are as follows:

FIG. 1 is a front view of the present invention;

FIG. 1A is an enlarged drawing of the direction key of the present invention;

FIG. 2 is an outspread 3-D view of the monitor of the present invention;

FIG. 3 is an outspread side view of the monitor of the present invention; and

FIG. 4 is an outspread plan view of the monitor of the present invention.

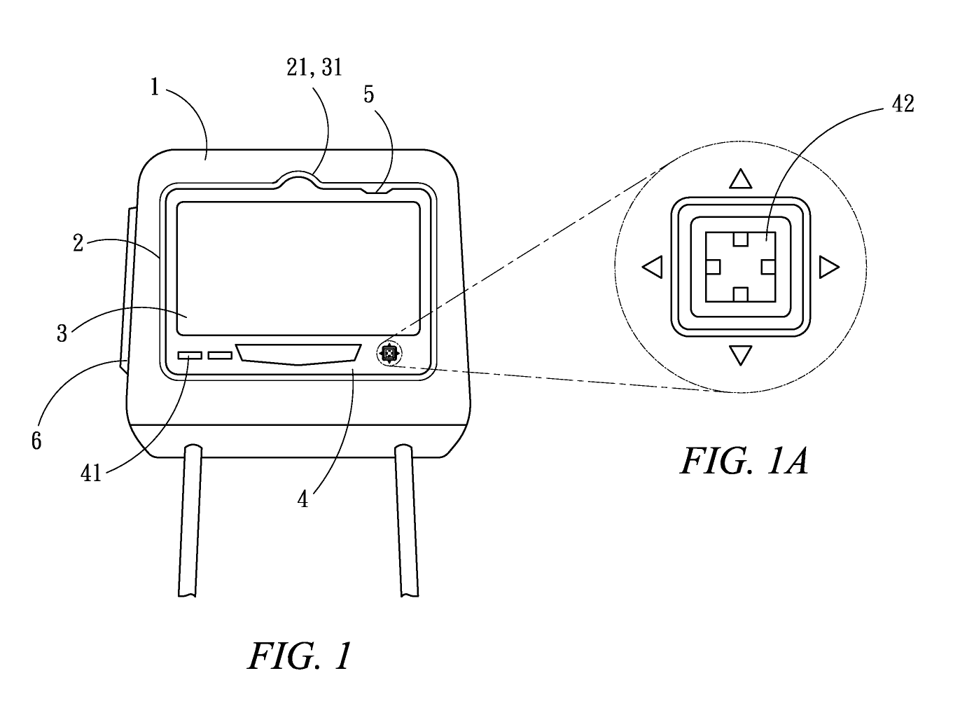

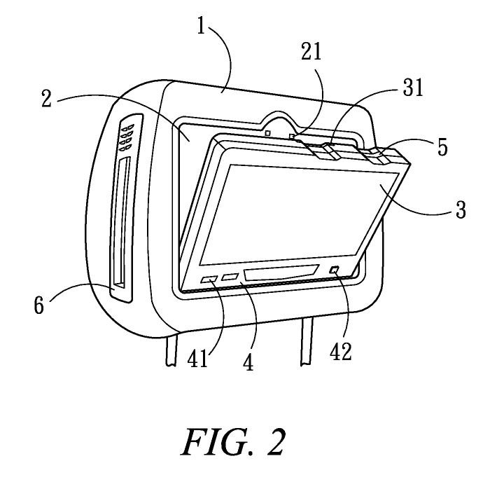

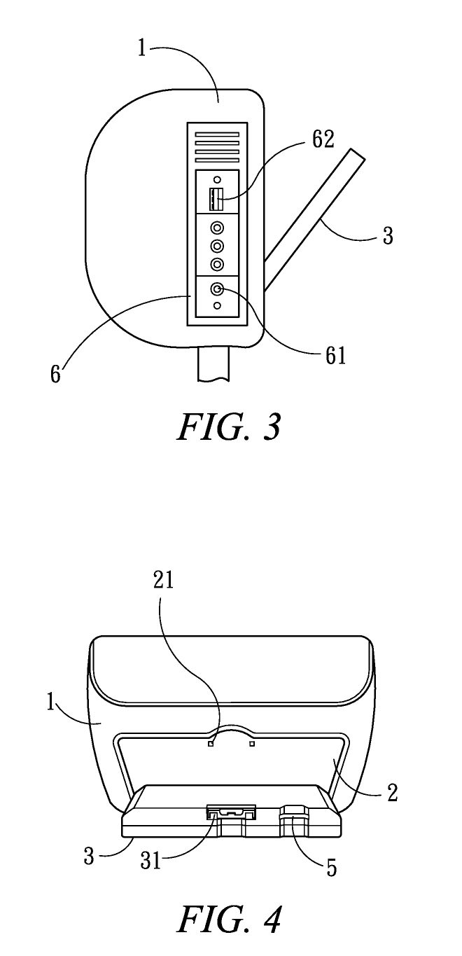

### DESCRIPTION OF THE PREFERRED EMBODIMENT

The present invention provides an interior liquid crystal and multimedia data display with a main apparatus set in the back of a headrest 1 installed on the seat of a car, including a container 2, a monitor 3, a control panel 4, an extension slot 5, and a peripheral panel 6, so that backseat passengers may conveniently watch videos on the back of the headrest 1. The container 2 is installed in the back of the headrest 1 to contain other apparatuses and related circuits. The monitor 3 is set in the container 2, wherein the container 2 is axially connected to the monitor 3 at a bottom edge thereof, thereby the monitor 3 is able to be turned over outwardly from the container 2 or to be pushed back toward the container 2 to be leveled with the headrest in order not to occupy the narrow space in the car, and can be screwed outward to lay out and to run other functions. The control panel 4, for the use of controlling different functions of the present invention, is set below the monitor 3 with a plurality of function keys 41 and a direction key 42. The function keys 41 controls basic video/audio playing functions, while the direction key is a five-axis direction apparatus with five control types of forward control, backward control, left control, right control, and push control, respectively. With the built-in system software of the present invention, GUI can be displayed on the monitor 3, and an easier, diverse way of operation can be provided to users. The extension slot 5, at the upper edge of the monitor 3, is concealed between the monitor 3 and the container 2 and is revealed only when users open the monitor 3. In addition, the peripheral panel 6 is set at the side of the headrest 1, in which the peripheral panel 6 has a surface with a plurality of output and input ports, including but not limited to basic analog plugs 61 for microphones, speakers, and other multimedia equipments, and digital plugs 62 for USB and IEEE 1394, wherein with the built-in system software of the present invention, input signals from other digital equipments like cameras or video cameras can be directly played on the monitor 3.

Moreover, the monitor 3 and the container 2 are connected with each other by lock structures 21 and 31 for conveniently fastening or pushing back the monitor 3, eschewing accidental unlocking caused by the vibration of car. And the extension slot 5 is mainly a memory slot for being inserted with a memory card compliant with standards of SD, MMC, MS, SM, and XD. High storage memory cards at present can be inserted into the extension slot 5 and the video/audio content inside can be directly played back.

With the aforementioned apparatus, when operating the present invention, users open the lock structure 21, 31 to spread up the monitor 3, and then insert a memory card with video/audio contents into the extension slot 5 to play the content through the control panel 4. By definition, with the different plugs provided by the peripheral panel 6, users may plug earphones or microphones in to enjoy a multimedia experience; they can also play digital information taken in trips directly on the monitor 3 through digital plugs 62 for USB or IEEE 1394 on the peripheral panel 6.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An interior liquid crystal and multimedia data display being set in the back of a headrest installed on the seat of a car, in which the interior liquid crystal and multimedia data display is characterized in that:
a container, being set in the back of the headrest;
a monitor, being set in the container, wherein the container is axially connected to the monitor at a bottom edge thereof, thereby the monitor is able to be turned over outwardly from the container or to be pushed back toward the container to be leveled with the headrest;
a control panel, being set below the monitor with a plurality of function keys and a direction key;
an extension slot, being set above the monitor and concealed between the monitor and the container; and
a peripheral panel, being set at a side of the headrest, in which the peripheral panel has a surface with a plurality of output ports and a plurality of input ports for being connected to other multimedia equipments.

2. The interior liquid crystal and multimedia data display as claimed in claim 1, wherein the monitor and the container are connected to each other by a lock structure for conveniently turning over or pushing back the monitor.

3. The interior liquid crystal and multimedia data display as claimed in claim 1, wherein the direction key is a five-axis direction apparatus with five control types of forward control, backward control, left control, right control, and push control, respectively.

4. The interior liquid crystal and multimedia data display as claimed in claim 1, wherein the extension slot is a memory slot for being inserted with a memory card compliant with standards of SD, MMC, MS, SM, and XD.
